(19) United States
(12) Patent Application Publication
(10) Pub. No.: US 2014/0337753 A1
(43) Pub. Date: Nov. 13, 2014

(54) SYSTEM AND METHOD FOR EDITING THE APPEARANCE OF A USER INTERFACE

(71) Applicants: Brian McKellar, Heidelberg (DE); Steffen Knoeller, Neupotz (DE); Frederic Berg, Heidelberg (DE)

(72) Inventors: Brian McKellar, Heidelberg (DE); Steffen Knoeller, Neupotz (DE); Frederic Berg, Heidelberg (DE)

(21) Appl. No.: 13/889,141

(22) Filed: May 7, 2013

(51) Int. Cl. G06F 3/0484

(52) U.S. Cl. CPC G06F 3/04842
USPC 715/747

(57) ABSTRACT

A UI editing machine may edit a target UI. The machine may access an image that depicts a window of the target UI. The machine may access a theme configuration for the target UI. The machine may display the image and a color selector operable by a user to select a proposed color for a portion of the image that depicts an element of the target UI. The machine may receive a color selection generated by the color selector. The machine may generate a modified version of the image by modifying the color of the portion of the image depicting the element to the proposed color. The machine may display the modified version of the image on a display device. The machine may modify the theme configuration for the target UI to specify the proposed color of the element.

### TECHNICAL FIELD

The subject matter disclosed herein generally relates to the processing of data. Specifically, the present disclosure addresses systems and methods to facilitate the editing of the appearance of a user interface (“UI”).

### BACKGROUND

Users interact with computer applications through UIs. Some examples of UIs include a command-line interface, a graphical user interface, a windowed interface, a web browser interface, and any suitable combination thereof. The UI of a stand-alone application can be revised by a computer programmer altering the source code of the application and creating a new version of the application. The programmer may use a machine to alter the UI and generate a new application. For a user to begin using the updated UI, the modified application may be installed in place of, or in addition to, the original application.

Some stand-alone applications allow modification of their UIs by modifying configuration files that correspond to the application (e.g., stored outside of the applications themselves). The UI of such a stand-alone application can be revised by a user altering the configuration file. For a user to begin using the updated configuration file, the configuration file may be reloaded, typically by restarting the application.

A web-based application may present its UI within a web browser. The browser may be configured to interpret files containing Hypertext Markup Language (“HTML”). HTML is a standard that is periodically revised. The proposed standard for HTML5 (the “HTML5 Standard”) is available in W3C Candidate Recommendation 17 Dec. 2012. Each file may be identified to the browser by a Uniform Resource Locator (“URL”). The UI of the web-based application can be revised by an administrator altering the HTML file associated with the web-based application. The administrator may use a machine to alter the HTML and generate a new UI. A user can begin using the updated UI by reloading the HTML file.

A URL may indicate a resource by a string of the form <scheme><host><port><path><query><fragment>. When one or more of the scheme, the host, the port, the path, the query, and the fragment are not present, a default value may be used for that field. The host may be indicated by an Internet Protocol (“IP”) address, or a name that can be resolved to an IP address by a Domain Name System (“DNS”) server. Many HTML tags use URLs to indicate network resources. For example, the “a” tag, which indicates a hyperlink, includes an “href” attribute, the value of which is the URL to be linked. As another example, the “img” tag, which indicates an image, includes a “src” attribute, the value of which is the URL of the image to be displayed.

When the scheme of a URL is “data:”, the remainder of the URL may be replaced with a string of the form <mediatype>, <data>. Such a URL is referred to as a “data URL.” This URL scheme is defined by the Network Working Group Request for Comments 2397, August 1998. The mediatype may conform to the Multipurpose Internet Mail Extensions (MIME) Part Two: Media Types standard put forth in Network Working Group Request for Comments 2046, November 1996. The data may be represented as a sequence of ASCII characters for byte values within the range allowed by the URL standard, and as a series of characters indicating the hexadecimal value of each byte when the byte value is not a valid character. For example, the sequence “%20” may be used to represent a space. An optional “;base64” string may appear immediately following the mediatype. If the “;base64” string is present, then the sequence of bytes is stored by storing the 24 bits of each set of three bytes into four ASCII characters. Each character can have one of 64 values, hence the name “base64.” The 64 values are a-z, A-Z, 0-9, “+”, and

An HTML document can be represented in memory by a Document object. The tags of the HTML document generate corresponding objects in the Document object. Thus, the resulting data structure is often referred to as a Document Object Model (“DOM”). By manipulating the DOM in memory, a web browser can dynamically alter the UI of a web application being presented to a user.

### BRIEF DESCRIPTION OF THE DRAWINGS

Some embodiments are illustrated by way of example and not limitation in the figures of the accompanying drawings.

FIG. 1 is a network diagram illustrating a network environment suitable for editing a UI, according to some example embodiments.

FIG. 2 is a block diagram illustrating components of a machine suitable for editing a UI, according to some example embodiments.

FIG. 3 is a block diagram illustrating components of an administrator device suitable for editing a UI, according to some example embodiments.

FIG. 4 is a screen diagram showing a window of an editor UI suitable for selecting proposed changes for a target UI, according to some example embodiments.

FIG. 5 is a screen diagram showing a window of an editor UI suitable for confirming a proposed change for a target UI, according to some sample embodiments.

FIG. 6-9 are flowcharts illustrating operations of a machine in performing a method of editing a UI, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to the editing of one or more UIs. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A UI editing machine (e.g., a device, a computer, an appliance, an electronic book reader, a set-top box, a smartphone, or any suitable combination thereof) may edit a UI. The UI being edited may be referred to as the target UI. An application that makes use of the target UI to present information to a user and receive input from the user may be referred to as the target application. The UI editing machine may access a theme configuration data that specifies an initial color of an element of the target UI. The theme configuration data may be accessed by retrieving the theme configuration data from storage (e.g., stored in a memory, a file, or a database) or receiving the theme configuration data in a signal. The UI element (e.g., a text field, a background, a drop-down menu, a radio button, a checkbox, an icon, a menu, a button, a list box, a window, a hyperlink, a combo box, a cycle button, a datagrid, a tab, a cursor, a pointer, or any suitable combination thereof) presents output to a user or receives input from a user. The UI may include a single window or multiple windows.

In some example embodiments, the color of the element is specified by one or more color values (e.g., a red-green-blue (“RGB”) color value, a cyan-magenta-yellow-black (“CMYK”) color value, a color value including an index into a table of other color values, a human-readable color value (e.g., “red,” “blue,” or “green”), or any suitable combination thereof). Furthermore, a single color value may be used to define a range of colors. For example, a rectangular background element that has its color specified by the color value “blue” may be displayed with a horizontal white stripe at the top and a horizontal blue stripe at the bottom with shades of blue forming a gradient between them. In another example, a background with two RGB color values, e.g., (0, 128, 0) and (128, 128, 128) may be displayed with a vertical stripe with color (0, 128, 0) at the left and a vertical stripe with color (128, 128, 128) at the right with linearly varying shades between them. Instead of or in addition to the spatial gradient of the previous examples, a temporal gradient may be applied. That is, a UI element may change color over time based on one or more color values. In one example, a cursor with a color value of “red” may smoothly vary between, e.g., black and the specified color of red. In another example, a cursor with two RGB color values, e.g., (0, 128, 0) and (128, 128, 128) may initially be displayed with a color of (0, 128, 0), then the red and green values increased over time until the color value of the displayed cursor reaches (128, 128, 128), at which time the color value begins returning to (0, 128, 0).

The UI editing machine may access an image (e.g., a raster image, a two-dimensional (2D) vector image, a three-dimensional (3D) vector image, or a suitable combination thereof) that depicts a window of the target UI. The image may include a single continuous area or multiple discontinuous areas. The window of the target UI may include the UI element specified in the theme configuration data. The color of a portion of the image may match the color specified in the theme configuration data.

The UI editing machine may display the image and a color selector that is operable by a user to select a proposed color for the portion of the image that depicts the element of the UI. The image may be displayed on a display device (e.g., a cathode-ray tube (“CRT”) monitor or a liquid-crystal display (“LCD”)). In some example embodiments, the display device is connected to the UI editing machine, either directly or over a network. The color selector may itself be a UI element.

The UI editing machine may receive a color selection generated by the color selector. The color selection may indicate the proposed color for the element. In some example embodiments, the color selection indicates the proposed color by providing a color value. In other example embodiments, the color selection indicates the proposed color by identifying a pixel in the image having the desired color. In such embodiments, the UI editing machine determines the color identifier from the color of the pixel. The color selection may also indicate the portion of the image that depicts the element for which the color is selected. In some example embodiments, the portion of the image is indicated by color. For example, when the portion of the image that depicts the element has an RGB color value of (10, 0, 0) and no other portion of the image has that color value, the portion of the image depicting the element may be identified by the RGB color value (10, 0, 0). In other example embodiments, the element itself is identified by the color selector. In such embodiments, the UI editing machine may access a data structure that maps the identifier of the element to the portion of the image that depicts the element.

The UI editing machine may generate a modified version of the image by modifying the color of the portion of the image depicting the element to the proposed color. The generation of the modified version of the image may be in response to the color selection. In some example embodiments, the modification is performed by replacing the color of the portion directly in the image. In alternative example embodiments, the modification is performed by modifying a lookup table through which the colors of the image are indirectly determined. The modified version of the image may depict a proposed appearance of the window of the target UI. The proposed appearance of the window may represent a proposed effect of the proposed color on the theme configuration data.

In some example embodiments, the modified version of the image shows an approximate impact of applying the proposed color to the theme configuration data. For example, if the element is a text field and the proposed color is “blue,” the impact on the UI of applying the proposed color to the theme configuration data may be to cause multiple shades of blue to appear in the background of the text field. In this example, the modified version of the image may show the color of the portion of the image depicting the background of the text field as a single shade of blue. As another example, if the element is a cursor and the proposed color is “red,” the impact on the UI of applying the proposed color to the theme configuration data may be to cause the color of the cursor to change between different shades of red over time. In this example, the modified version of the image may show the color of the portion of the image depicting the cursor as a single, unchanging, shade of red.

The UI editing machine may display the modified version of the image on a display device. In some example embodiments, the display is connected directly to the UI editing machine. In alternative example embodiments, the display is connected by a network.

The UI editing machine may generate a modified version of the theme configuration data. In some example embodiments, the theme configuration includes multiple pieces of theme configuration data. In some example embodiments, the modified version of the theme configuration data specifies the proposed color of the element of the UI. The modified version of the theme configuration data may be stored in a memory, stored in a file, stored in a database, transmitted over a network, or any suitable combination thereof.

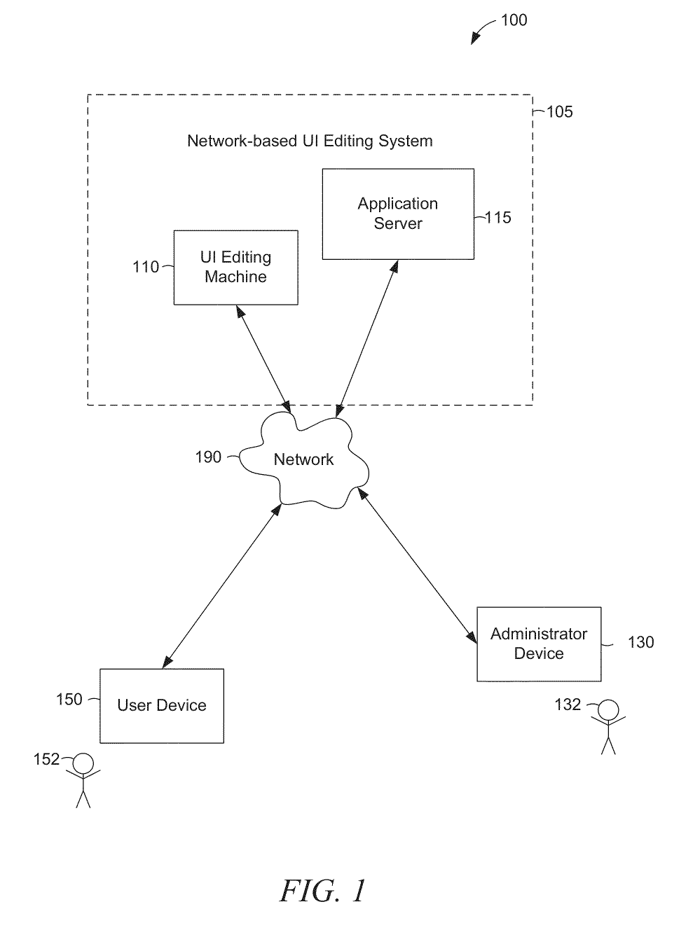

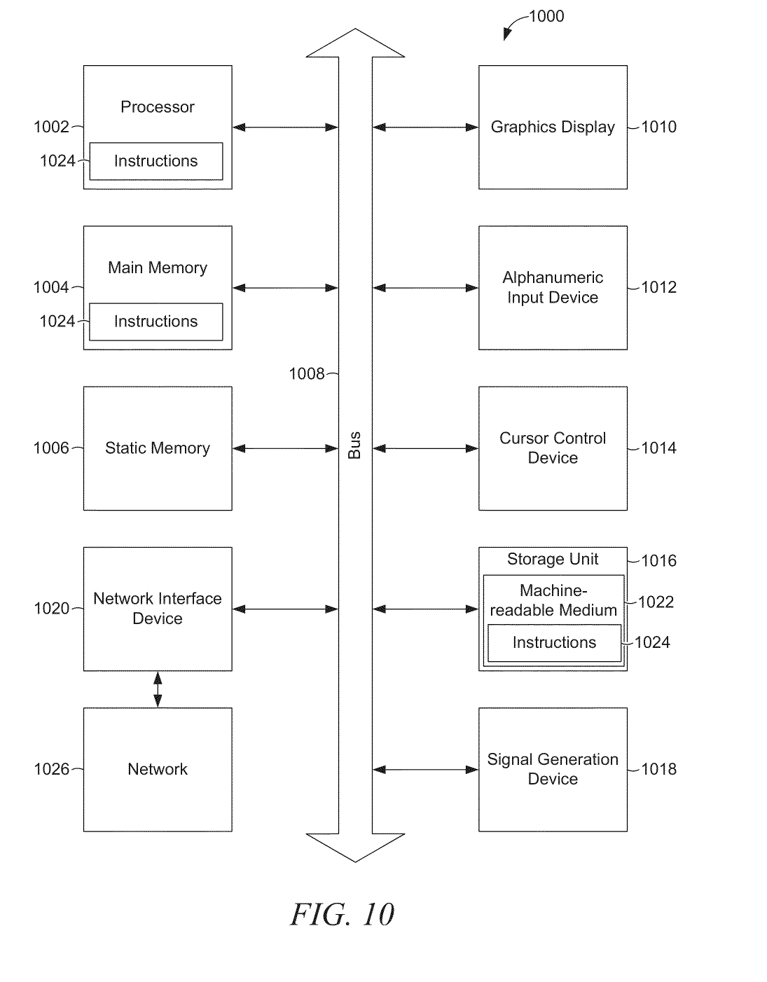

FIG. 1 is a network diagram illustrating a network environment 100 suitable for UI editing, according to some example embodiments. The network environment 100 includes a network-based UI editing system 105, a UI editing machine 110, an application server 115, an administrator device 130, and a user device 150, all communicatively coupled to each other via a network 190. In some example embodiments, the application server 115 is connected by the network 190 to the UI editing machine 110 and the devices 130 and 150. The UI editing machine 110 and the devices 130 and 150 may each be implemented in a computer system, in whole or in part, as described below with respect to FIG. 10.

The network-based UI editing system 105 may include UI editing machine 110 and application server 115. The network-based UI editing system may provide the elements and services of each of UI editing machine 110 and application server 115, as described in more detail below.

The UI editing machine 110 may provide a UI editing application to other machines (e.g., the application server 115, the administrator device 130, or the user device 150) via the network 190. The UI editing application may present a UI to an administrator 132.

The application server 115 may provide applications (e.g., business applications, entertainment applications, or both) to other machines (e.g., the UI editing machine 110, the administrator device 130, or the user device 150) via the network 190. Each of these applications may present a UI to a user 152.

Also shown in FIG. 1 are an administrator 132 and a user 152. One or both of the administrator 132 and user 152 may be a human (e.g., a human being), a machine (e.g., a computer configured by a software program to interact with the device 130), or any suitable combination thereof (e.g., a human assisted by a machine or a machine supervised by a human). The administrator 132 is not part of the network environment 100, but is associated with the device 130. As an example, the device 130 may be a desktop computer, a vehicle computer, a tablet computer, a navigational device, a portable media device, or a smart phone belonging to the administrator 132. Likewise, the user 152 is not part of the network environment 100, but is associated with the device 150 and may be a user of the device 150. For example, the device 150 may be a desktop computer, a vehicle computer, a tablet computer, a navigational device, a portable media device, or a smart phone belonging to the user 152.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the UI editing machine 110 and the administrator device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

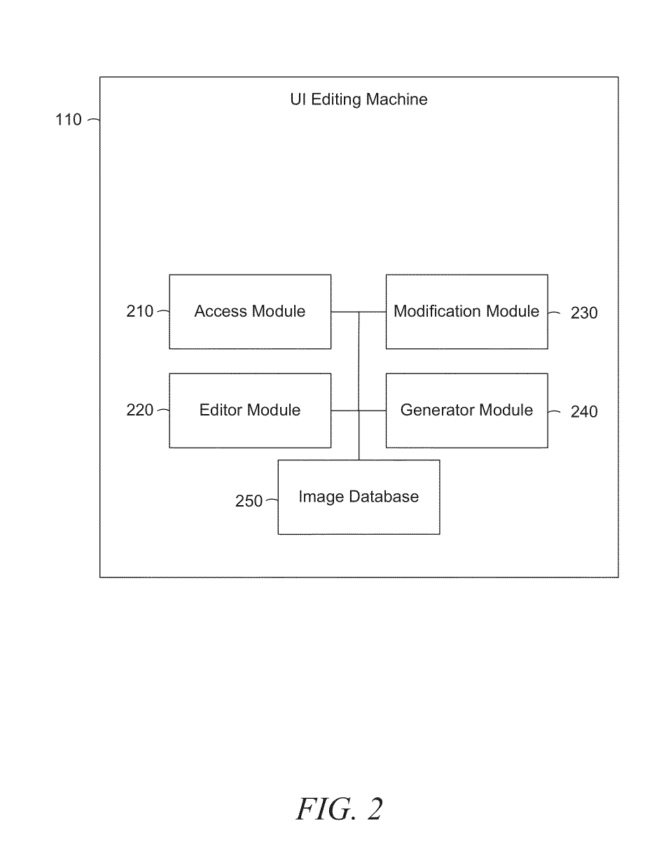

FIG. 2 is a block diagram illustrating components of the UI editing machine 110, according to some example embodiments. The UI editing machine 110 is shown as including an access module 210, an editor module 220, a modification module 230, a generator module 240, and an image database 250, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In some example embodiments, the access module 210 is configured (e.g., by software) to access a theme configuration data that specifies a color of an element of a UI. For example, the UI may be the UI of an application served by the application server 115. In some example embodiments, the access module 210 is configured to access the theme configuration data in response to a selection made by a user (e.g., the administrator 132).

In some example embodiments, the access module 210 is configured to access an image that depicts a window of the UI. A portion of the image may depict the element of the UI specified in the theme configuration data. In some example embodiments, the color of the portion of the image depicting the element matches the color specified for the element in the theme configuration data. In some example embodiments, the access module 210 is configured to receive a selection by a user (e.g., a selection of the image, a selection of the target UI, a selection of a window of the target UI, a selection of the target application, or any suitable combination thereof). In these example embodiments, the access module 210 is configured to access the image in response to the selection.

In some example embodiments, the access module 210 is configured to access the image via a data URL. In other example embodiments, the access module 210 is configured to access the image from a file. In still other example embodiments, the access module 210 is configured to access the image from a database. In some example embodiments, the editor module 220 is configured to display the image accessed by access module 210.

In some example embodiments, the editor module 220 is configured to display a color selector. For example, the color selector may include one or more text fields, an RGB color selector, a pixel selector, or any suitable combination thereof. The RGB color space may be defined as a cube with shades of red, green, and blue varying respectively along the x, y, and z axes. One representation of the RGB color space is a 2D area showing a 2D slice of the RGB color cube and a one-dimensional (1D) line showing the third dimension. An RGB color selector may be implemented by displaying such a 2D area and 1D line. The user may interact with such a color selector by selecting a value on the ID line and a coordinate pair in the 2D area, thus specifying a unique RGB value. Similar graphic representations are possible for other color spaces. Alternatively, text fields can also be used to specify a color value. For example, grey may be specified as “grey,” by the RGB color value (128, 128, 128), or both. In yet another example embodiment, a pixel selector allows the user to choose an existing pixel in the image. In such an example embodiment, the selected color is the color of the selected pixel.

In some example embodiments, the color selector generates a color selection. In these example embodiments, the color selection indicates a proposed color for the element of the UI specified in the theme configuration data. In some example embodiments, the editor module 220 receives the color selection generated by the color selector. The editor module 220 may generate a modified theme configuration that specifies the proposed color for the element of the UI. For example, the editor module 220 may generate a new theme configuration, modify the existing theme configuration data, or both.

In some example embodiments, the modification module 230 is configured to modify the image accessed by access module 210. For example, the image may be modified by modifying the color of the portion of the image that depicts the element of the UI. In particular, the color of the portion of image may be modified to the proposed color. In some example embodiments, the modified version of the image depicts a proposed appearance of the UI window depicted in the image. For example, the proposed appearance of the window of the UI may represent a proposed effect of the proposed color on the theme configuration. In some example embodiments, modification module 230 is configured to modify the image in response to the color selection received by editor module 220. In some example embodiments, the modification module 230 is configured to modify the image by modifying the data of the corresponding object in a DOM.

In some example embodiments, the DOM is modified by adding, deleting, or modifying objects, or any suitable combination thereof. An image object in a DOM may be modified by the modification module 230 by modifying the graphics data stored in memory that is used to generate the image, by modifying a file referenced by the object, by modifying the object to reference a different or additional file, or any suitable combination thereof.

In some example embodiments, the generator module 240 is configured to generate the image accessed by the access module 210 based on an execution of an application. In some example embodiments, the image generated by the generator module 240 is a screenshot of the target UI. In other example embodiments, the image generated by the generator module 240 is created without displaying the image. The generator module 240 may be configured to provide a UI that includes a graphical control that is operable to submit a user command. In such embodiments, the generator module 240 may generate the image in response to a user command submitted via the graphical control. In some example embodiments, the generator module 240 is configured to transmit the image to the access module 210. In alternative example embodiments, the generator module 240 is configured to store the generated image in image database 250.

In some example embodiments, the image generated by the generator module 240 manipulates the colors of the pixels of the image to store information. For example, information about the element depicted by each pixel may be encoded in the color of the pixel. For example, if the colors are encoded in a Red Green Blue Alpha (“RGBA”) color scheme, where the alpha value represents transparency, the alpha channel can be overloaded and used to store an element index value. In this example, the editor module 220 may be configured to ignore the alpha channel when displaying the image, while modification module 230 uses the alpha channel to identify the pixels to be modified by a color selection. In another example embodiment, using an RGB color scheme, the color of pixels not depicting modifiable elements may be stored as their actual displayed colors while the color of pixels depicting modifiable elements may be stored with color values indicating the element being depicted. For example, the pixels depicting element one may be stored as having RGB color value (0,0,1). In such an embodiment, the color of the element may be stored in the theme configuration. Continuing with this example embodiment, the editor module 220 may be configured to replace the RGB color value indicating an element with the color for the element indicated in the theme configuration data. In such an example embodiment, modification module 230 may use the color information in the unmodified image to determine which pixels depict a particular element, and should be modified in response to a color selection.

In some example embodiments, the image is stored in image database 250. The image may be accessed by the access module 210. The image database 250 may also store the theme configuration data.

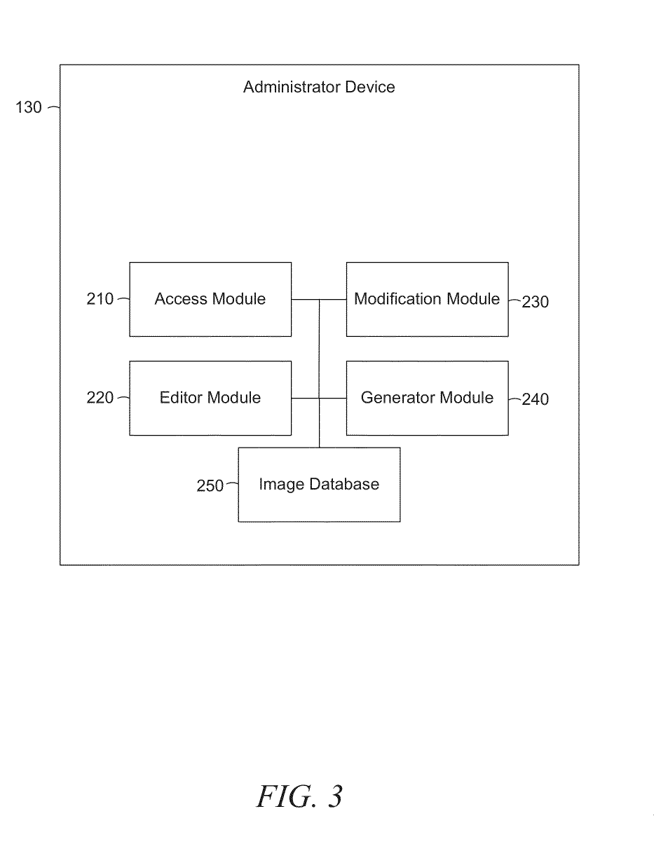

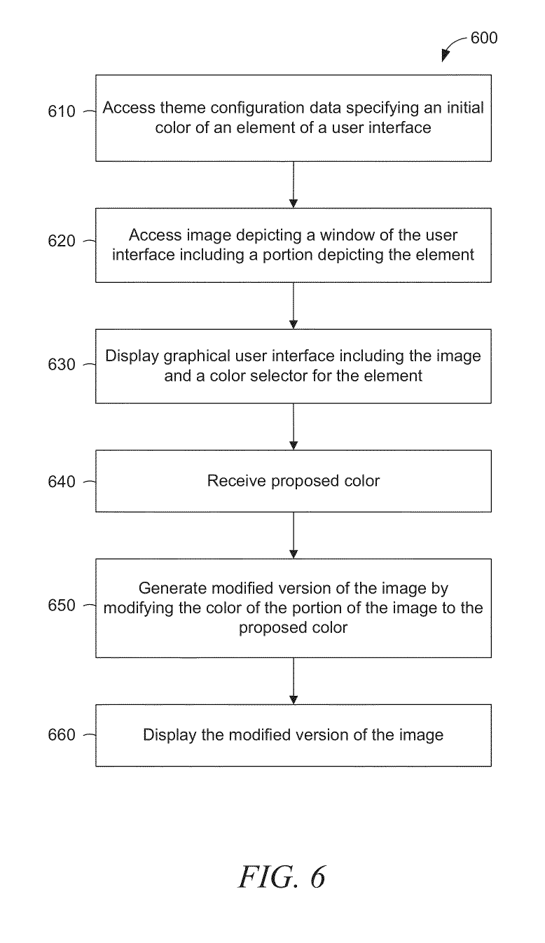

FIG. 3 is a block diagram illustrating components of the administrator device 130, according to some example embodiments. The administrator device 130 is shown as including the access module 210, the editor module 220, the modification module 230, the generator module 240, and the image database 250, all configured to communicate with each other (e.g., via a bus, shared memory, or a switch). These modules are discussed above with respect to FIG. 2. Further details of the operations performed by these modules are discussed below with respect to FIG. 6-9.

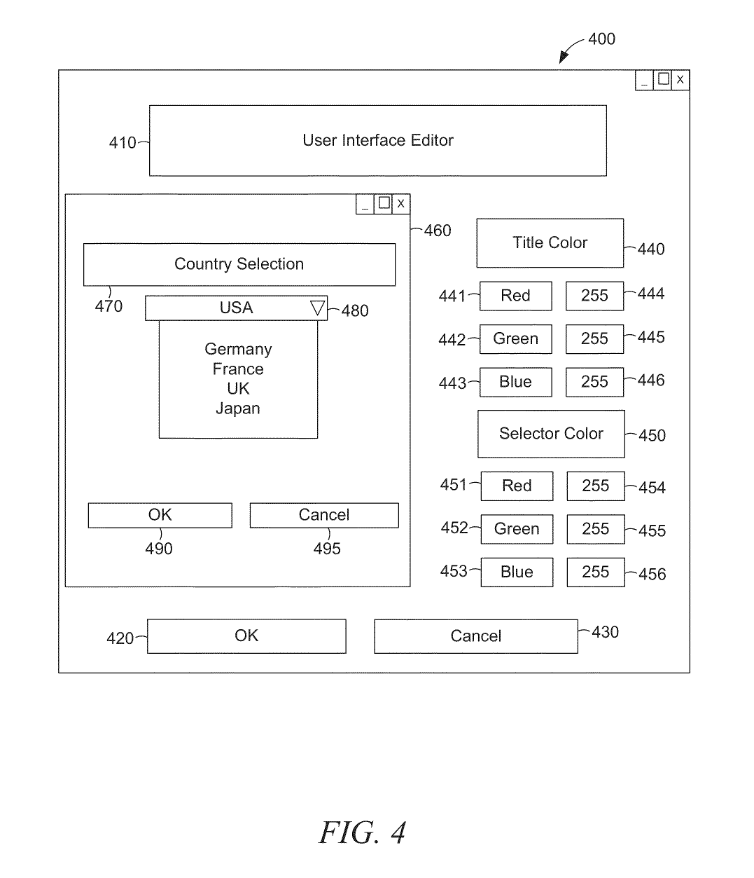

FIG. 4 is a screen showing a window of a UI of the UI editing application, according to some example embodiments. Screen 400 is shown as including a title 410, buttons 420 and 430, an image 460, and two color selectors including label elements 440-443 and 450-453 and text fields 444-446 and 454-456. The image 460 is shown as depicting an image of a window of the target UI, including portions depicting UI elements 470, 480, 490, and 495

In some example embodiments, the title 410 includes text indicating the name of the UI editing application. In other example embodiments, the title 410 is indicated graphically (e.g., by a logo). In other example embodiments, the title 410 may indicate the name of the target application.

In some example embodiments, the button 420 is operable by a user to submit a proposed color to the UI editing application. For example, after specifying red, green, and blue components of an RGB value in the text fields 444-446, the user may click the button 420 to submit the specified values.

In some example embodiments, the button 430 is operable by a user to reset a proposed color to its default value. For example, after specifying red, green, and blue components of an RGB color value in the text fields 444-446, the user may click the button 430 to indicate that the specified value is undesired, and to request the UI editing application to reset the text fields to their original states.

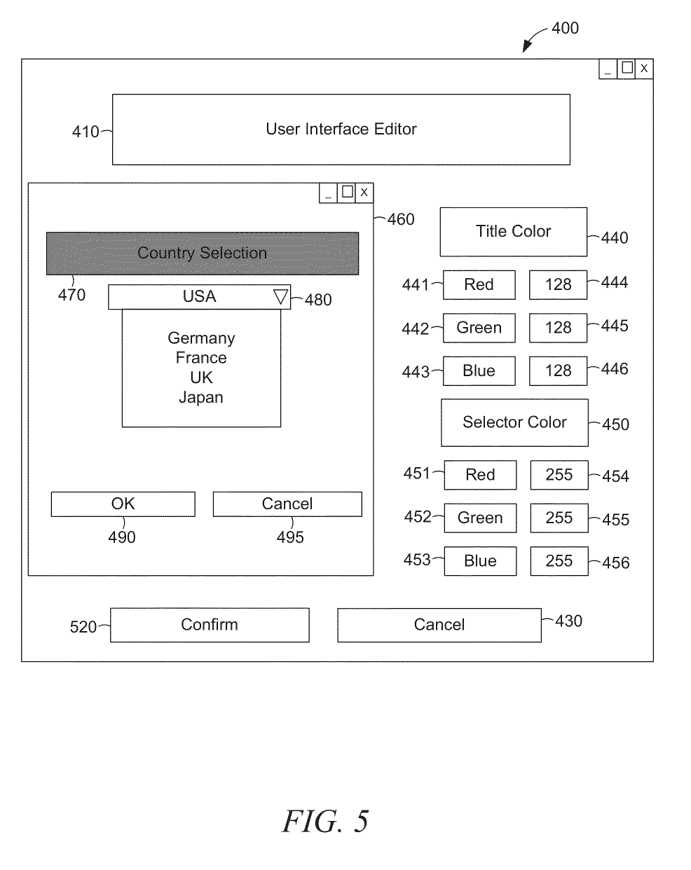

In some example embodiments, the UI elements 440-446 are part of a color selector. As shown in FIG. 4-5, the label element 440 contains the text “Title Color.” In this example embodiment, this text indicates to the user the portion of the image 460 affected by the color selector. In this example embodiment, this text also indicates to the user the UI element of the target UI that will be impacted by a change to the theme configuration data generated by the color selector. As shown in FIG. 4-5, three label elements 441-443 contain the text “Red,” “Green,” and “Blue,” respectively. In this example embodiment, this text indicates to the user that the three input elements 444-446 may be used to enter the RGB color value desired for the title color.

In some example embodiments, the UI label elements 450-456 are part of a color selector. As shown in FIG. 4-5, the label element 450 contains the text “Selector Color.” In this example embodiment, this text indicates to the user the portion of the image 460 affected by the color selector. In this example embodiment, this text also indicates to the user the UI element of the target UI that will be impacted by a change to the theme configuration data generated by the color selector. As shown in FIG. 4-5, the three label elements 451-453 contain the text “Red,” “Green,” and “Blue,” respectively. In this example embodiment, this text indicates to the user that three elements 454-456 may be used to enter the RGB color value desired for the selector color.

In some example embodiments, the image 460 depicts a window of the target UI. As shown in FIG. 4-5, portions of the image 470, 480, 490, and 495 depict UI elements of the target UI. In this example, the portion 470 depicts a title, “Country Selection.” Also in this example, the portion 480 depicts a drop-down menu with five menu options: “USA,” “Germany,” “France,” “UK,” and “Japan.” Continuing with this example, the portions 490 and 495 depict buttons operable by the user of the target UI to confirm or reject changes made in the country selection window.

FIG. 5 is a screen showing a window of the editor UI suitable for confirming a proposed change for the target UI, according to some sample embodiments. In this example, a user has replaced the default RGB value of (255, 255, 255) shown in the input elements 444-446 in FIG. 4 with a new value (128, 128, 128) shown in the elements 444-446 in FIG. 5. As a result, FIG. 5 shows the portion 470 of the image 460 being depicted in the new color. FIG. 5 also shows that the “OK” button 420 has been replaced with a “confirm” button 520. In some example embodiments, the button 520 is operable by the user to confirm that the depicted change in image 460 is desirable. In such embodiments, the proposed change to the theme configuration data may be stored in response to the operation of the button 520.

FIG. 6-8 are flowcharts illustrating operations of the machine 110 or device 130 in performing a method 600 of editing a UI, according to some example embodiments. Operations in the method 600 may be performed by the machine 110 or the device 130, using modules described above with respect to FIG. 2-3. As shown in FIG. 6, the method 600 includes one or more of operations 610, 620, 630, 640, 650, and 660.

In operation 610, the access module 210 accesses a theme configuration data that specifies a color of an element of a UI. The theme configuration data may be accessed by retrieving the theme configuration data from storage (e.g., stored in a memory, a file, or a database) or receiving the theme configuration data in a signal. As noted above, the UI element may present output to a user, receive input from a user, or both. Additional details of the UI element are discussed above with respect to FIG. 2-5.

In operation 620, the access module 210 accesses an image associated with the theme configuration data that depicts a window of the UI including a portion that depicts the element. The image and the portion each may include a single continuous area or multiple discontinuous areas. The window of the target UI may include a UI element specified in the theme configuration data. The color of a portion of the image may match the color specified in the theme configuration data. The association between the image and the theme configuration data may be indicated by a table in a database; by data stored within files; by the location of files on a disk; by virtue of a relationship between the theme configuration data, the image, and the target application; or by any suitable combination thereof.

In operation 630, the editor module 220 causes the display of a graphical user interface including the image and a color selector that allows a user to select a proposed color for the portion of the image that depicts the element of the UI. The graphical user interface may be displayed on a display device. In some example embodiments, the display device is connected to the UI editing machine, either directly or over a network. The color selector may itself be a UI element. In operation 630, the image may be displayed by an application able to parse HTML. For example, an HTML page may be generated that includes a reference to the image in an “img” tag. In another example, an HTML page may be generated that includes the image in the document as a data URL. In this way, an administrator can edit the UI of various applications by using a web browser.

In operation 640, the editor module 220 receives a color selection generated by the color selector. The color selection may indicate the proposed color for the element, the element, the portion of the image that depicts the element, or any suitable combination thereof.

In operation 650, the modification module 230 generates a modified version of the image by modifying the color of the portion of the image depicting the element to the proposed color. The generation of the modified version of the image may be in response to the color selection.

In operation 660, the modification module 230 displays the modified version of the image on a display device. In some example embodiments, the display is connected directly to the UI editing machine. In alternative example embodiments, the display is connected by a network.

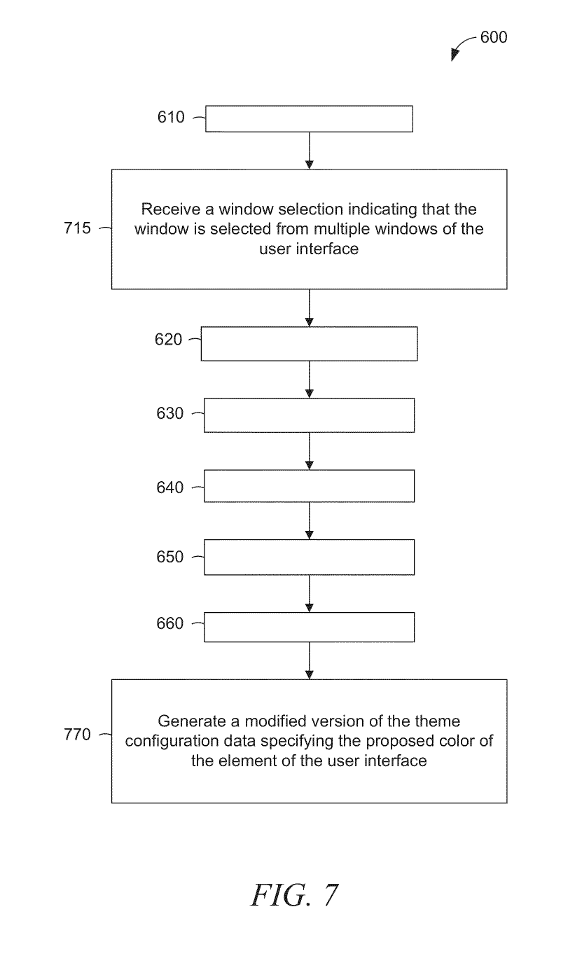

As shown in FIG. 7, the method 600 may include one or more of the operations 715 and 770. The operation 715 may be performed as part (e.g., a precursor task, a subroutine, or a portion) of operation 620, in which the image is accessed.

In operation 715, the access module 210 receives a window selection indicating the selected window and that the window is selected from multiple windows of the target UI. For example, the window selection may indicate that window 2 is selected, implying that at least two windows exist. In another example, the window selection may indicate that a window labeled “Country Selection” is selected. In some example embodiments, the window selection includes a numeric or text identifier for the window, or both. In some example embodiments, an image is available for each of the multiple windows of the target UI. In example embodiments with multiple images available, the window selection may be used to determine which of the images is accessed in operation 620.

In operation 770, the modification module 230 generates a modified version of the theme configuration data. In some example embodiments, the modified version of the theme configuration data specifies the proposed color of the element of the UI received in operation 640. The modified version of the theme configuration data may be stored in a memory, stored in a file, stored in a database, transmitted over a network, or any suitable combination thereof.

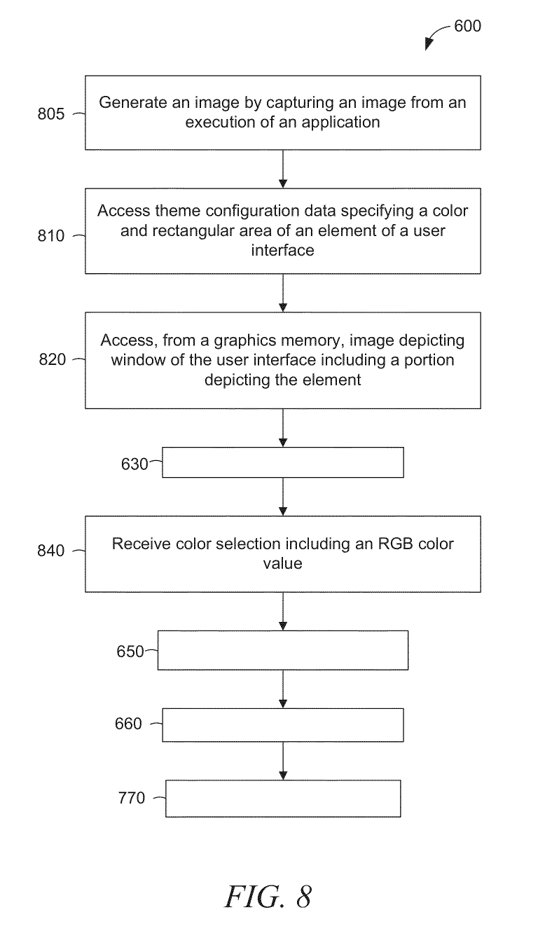

As shown in FIG. 8, the method 600 may include one or more of operations 805, 810, 820, and 840.

In operation 805 the generator module 240 generates an image by capturing an image from an execution of an application. In some example embodiments, the image generated by the operation 805 is a screenshot of the target UI. In other example embodiments, the image generated by the operation 805 is created without displaying the image. The operation 805 may include providing a UI that includes a graphical control that is operable to submit a user command. In such embodiments, the operation 805 may generate the image in response to a user command submitted via the graphical control. In some example embodiments, while the application executes, an image is displayed. In such embodiments, the image can be captured (e.g., from graphics memory).

In operation 810, the access module 210 accesses a theme configuration data specifying a color and a rectangular area of an element of a UI. For example, the UI may be the UI of the application from which an image was generated by the operation 805. In some example embodiments, the operation 810 accesses the theme configuration data in response to a selection made by a user.

In operation 820, the access module 210 accesses the image depicting the window of the UI from a graphics memory. The image may include a single continuous area or multiple discontinuous areas. The window of the target UI may include a UI element specified in the theme configuration data. The color of a portion of the image may match the color specified in the theme configuration data.

In operation 840, the editor module 220 receives a color selection including an RGB color value. The color selection may indicate the proposed color for the element, the element, the portion of the image that depicts the element, or any suitable combination thereof.

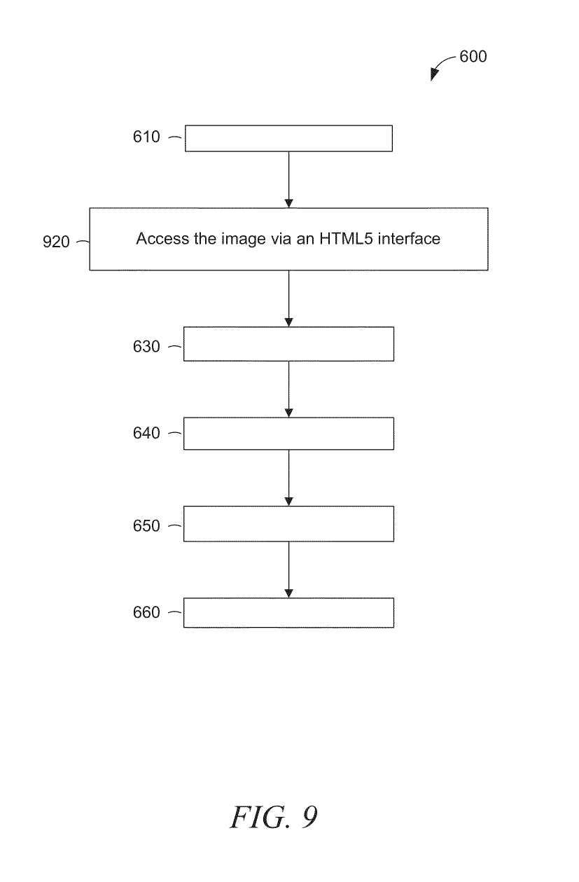

As shown in FIG. 9, the method 600 may include operation 920. In operation 920 the access module 210 accesses the image via an interface defined in the HTML5 Standard. This may benefit the administrator 132 by allowing the use of a common web browser (e.g., Internet Explorer, Firefox, or Chrome) to display and edit UIs. For example, operation 920 may access the image via an “img” tag. In some example embodiments, operation 920 accesses the image via the DOM.

According to various example embodiments, one or more of the methodologies described herein may facilitate editing of a UI for a target application by a machine that is not accessing the target application.

When these effects are considered in aggregate, one or more of the methodologies described herein may obviate a need for certain efforts or resources that otherwise would be involved in editing UIs. Efforts expended by an administrator in modifying the UIs of multiple target applications through separate editors may be reduced by one or more of the methodologies described herein. Efforts expended by a software developer in creating multiple applications may be reduced by providing a single UI editing application rather than embedding methods of UI configuration in each of the multiple applications. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 10 is a block diagram illustrating components of a machine 1000, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 10 shows a diagrammatic representation of the machine 1000 in the example form of a computer system and within which instructions 1024 (e.g., software, a program, an application, an applet, an app, or other executable code) for causing the machine 1000 to perform any one or more of the methodologies discussed herein may be executed, in whole or in part. In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include a collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The machine 1000 may further include a graphics display 1010 (e.g., a plasma display panel (PDP), a light emitting diode (LED) display, a liquid crystal display (LCD), a projector, or a cathode ray tube (CRT)). The machine 1000 may also include an alphanumeric input device 1012 (e.g., a keyboard), a cursor control device 1014 (e.g., a mouse, a touchpad, a trackball, a joystick, a motion sensor, or other pointing instrument), a storage unit 1016, a signal generation device 1018 (e.g., a speaker), and a network interface device 1020.

The storage unit 1016 includes a machine-readable medium 1022 on which is stored the instructions 1024 embodying any one or more of the methodologies or functions described herein. The instructions 1024 may also reside, completely or at least partially, within the main memory 1004, within the processor 1002 (e.g., within the processor's cache memory), or both, during execution thereof by the machine 1000. Accordingly, the main memory 1004 and the processor 1002 may be considered as machine-readable media. The instructions 1024 may be transmitted or received over a network 1026 (e.g., network 190 of FIG. 1) via the network interface device 1020.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., instructions 1024) for execution by a machine (e.g., machine 1000), such that the instructions, when executed by one or more processors of the machine (e.g., processor 1002), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits.” “values,” “elements,” “symbols.” “characters.” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods, machine-readable media, and systems (e.g., apparatus) discussed herein:

1. A method comprising:
accessing theme configuration data that specifies an initial color of an element of a user interface;
accessing an image associated with the theme configuration data, the image depicting a window of the user interface, a color of a portion of the image depicting the element corresponding to the initial color;
causing display of a graphical user interface including the image and a color selector, the color selector including a plurality of selectable colors;
receiving a selection of a proposed color of the plurality of selectable colors;
in response to the selection, generating, using a processor of a machine, a modified version of the image by modifying the color of the portion of the image to the proposed color; and
causing the modified version of the image to be displayed.

2. The method of description 1, further comprising:
generating a modified version of the theme configuration that specifies the proposed color for the element of the user interface.

3. The method of description 1 or description 2, wherein the window of the user interface is one window among multiple windows presentable as part of the user interface.

4. The method of description 3, further comprising:
receiving a window selection that indicates the window is selected by a user from the multiple windows presentable as part of the user interface; and wherein
the accessing of the image that depicts the window is based on the received window selection from the user.

5. The method of any of descriptions 1-4, further comprising generating the image by capturing the image from an execution of the application.

6. The method of description 5, wherein
the user interface provides a graphical control that is operable to interact with the application; and wherein the
generating of the image is in response to a user command submitted via the graphical control.

7. The method of any of descriptions 1-6, wherein the accessing of the image accesses the portion of the image, each of the element and the portion being rectangular.

8. The method of any of descriptions 1-7, wherein the accessing of the image accesses the image from a graphics memory.

9. The method of any of descriptions 1-8, wherein the receiving of the color selection receives an RGB color value.

10. The method of any of descriptions 1-9, wherein the accessing of the image accesses the image through an HTML5 interface.

11. The method of any of descriptions 1-10, wherein the displaying of the image displays the image in an application that is configured to parse HTML.

12. A non-transitory machine-readable storage medium comprising instructions that, when executed by one or more processors of a machine, cause the machine to perform operations comprising:
accessing theme configuration data that specifies an initial color of an element of a user interface;
accessing an image associated with the theme configuration data, the image depicting a window of the user interface, a color of a portion of the image depicting the element corresponding to the initial color;
causing a graphical user interface to be displayed, the graphical user interface including the image and a color selector, the color selector including a plurality of selectable colors;
receiving a selection of a proposed color of the plurality of selectable colors;
in response to the selection, generating, using a processor of a machine, a modified version of the image by modifying the color of the portion of the image to the proposed color; and
causing the modified version of the image to be displayed.

13. The non-transitory machine-readable storage medium of description 12, the operations further comprising:
generating a modified version of the theme configuration that specifies the proposed color for the element of the user interface.

14. The non-transitory machine-readable storage medium of any of descriptions 12-13, the operations further comprising:
receiving a window selection from a user that indicates that the window is selected by the user from multiple windows presentable as part of the user interface; and wherein
the accessing of the image that depicts the window is based on the received window selection from the user.

15. The non-transitory machine-readable storage medium of any of descriptions 12-14, wherein the operations further comprise generating the image based on an execution of the application.

16. The non-transitory machine-readable storage medium of description 15, wherein
the user interface provides a graphical control that is operable to interact with an application; and wherein
the generating of the image is in response to a user command submitted via the graphical control.

17. A system comprising:
an access module configured to:
   access theme configuration data that specifies an initial color of an element of a user interface; and
   access an image associated with the theme configuration data, the image depicting a window of the user interface, a color of a portion of the image depicting the element corresponding to the initial color; and
an editor module configured to:
   cause display of a graphical user interface including the image and a color selector, the color selector including a plurality of selectable colors; and
   receiving a selection of a proposed color of the plurality of selectable colors; and
a processor of a machine configured by a modification module to:
   generate, in response to receiving the selection, a modified version of the image by modifying the color of the portion of the image to the proposed color; and cause display of the modified version of the image.

18. The system of description 17, wherein the editor module is further configured to generate a modified version of the theme configuration that specifies the proposed color for the element of the user interface.

19. The system of any of descriptions 17-18, wherein the access module is further configured to
receive a window selection from a user, the window selection indicating that the window is selected by the user from multiple windows presentable as part of the user interface; and
access the image that depicts the window based on the received window selection from the user.

20. The system of any of descriptions 17-19, further comprising a generator module configured to:
generate the image based on an execution of the application;
provide a user interface that includes a graphical control that is operable to submit a user command; and
generate the image in response to the user command submitted via the graphical control.

What is claimed is:

1. A method comprising:
accessing a theme configuration data that specifies an initial color of an element of a user interface;
accessing an image associated with the theme configuration data, the image depicting a window of the user interface, a color of a portion of the image depicting the element corresponding to the initial color;
causing display of a graphical user interface including the image and a color selector, the color selector including a plurality of selectable colors;
receiving a selection of a proposed color of the plurality of selectable colors;
in response to the selection, generating, using a processor of a machine, a modified version of the image by modifying the color of the portion of the image to the proposed color; and
causing the modified version of the image to be displayed.

2. The method of claim 1, further comprising:
generating a modified version of the theme configuration that specifies the proposed color for the element of the user interface.

3. The method of claim 1, wherein the window of the user interface is one window among multiple windows presentable as part of the user interface.

4. The method of claim 3, further comprising:
receiving a window selection that indicates the window is selected by a user from the multiple windows presentable as part of the user interface; and wherein
the accessing of the image that depicts the window is based on the received window selection from the user.

5. The method of claim 1, further comprising
generating the image by capturing the image from an execution of the application.

6. The method of claim 5, wherein
the user interface provides a graphical control that is operable to interact with the application; and wherein
the generating of the image is in response to a user command submitted via the graphical control.

7. The method of claim 1, wherein
the accessing of the image accesses the portion of the image, each of the element and the portion being rectangular.

8. The method of claim 1, wherein the accessing of the image accesses the image from a graphics memory.

9. The method of claim 1, wherein the receiving of the color selection receives an RGB color value.

10. The method of claim 1, wherein the accessing of the image accesses the image through an HTML5 interface.

11. The method of claim 1, wherein the displaying of the image displays the image in an application that is configured to parse HTML.

12. A non-transitory machine-readable storage medium comprising instructions that, when executed by one or more processors of a machine, cause the machine to perform operations comprising:
accessing theme configuration data that specifies an initial color of an element of a user interface;
accessing an image associated with the theme configuration data, the image depicting a window of the user interface, a color of a portion of the image depicting the element corresponding to the initial color;
causing a graphical user interface to be displayed, the graphical user interface including the image and a color selector, the color selector including a plurality of selectable colors;
receiving a selection of a proposed color of the plurality of selectable colors;
in response to the color selection, generating, using a processor of a machine, a modified version of the image by modifying the color of the portion of the image to the proposed color; and
causing the modified version of the image to be displayed.

13. The non-transitory machine-readable storage medium of claim 12, the operations further comprising:
generating a modified version of the theme configuration that specifies the proposed color for the element of the user interface.

14. The non-transitory machine-readable storage medium of claim 12, the operations further comprising:
receiving a window selection from a user that indicates that the window is selected by the user from multiple windows presentable as part of the user interface; and wherein
the accessing of the image that depicts the window is based on the received window selection from the user.

15. The non-transitory machine-readable storage medium of claim 12, wherein the operations further comprise generating the image based on an execution of an application.

16. The non-transitory machine-readable storage medium of claim 15, wherein
the user interface provides a graphical control that is operable to interact with an application; and wherein
the generating of the image is in response to a user command submitted via the graphical control.

17. A system comprising:
an access module configured to:
access theme configuration data that specifies an initial color of an element of a user interface; and
access an image associated with the theme configuration data, the image depicting a window of the user interface, a color of a portion of the image depicting the element corresponding to the initial color; and
an editor module configured to:
cause display of a graphical user interface including the image and a color selector, the color selector including a plurality of selectable colors; and
receiving a selection of a proposed color of the plurality of selectable colors; and
a processor of a machine configured by a modification module to:
generate, in response to receiving the proposed color, a modified version of the image by modifying the color of the portion of the image to the proposed color; and
cause display of the modified version of the image.

18. The system of claim 17, wherein the editor module is further configured to generate a modified version of the theme configuration that specifies the proposed color for the element of the user interface.

19. The system of claim 17, wherein the access module is further configured to
receive a window selection from a user, the window selection indicating that the window is selected by the user from multiple windows presentable as part of the user interface; and
access the image that depicts the window based on the received window selection from the user.

20. The system of claim 17, further comprising
a generator module configured to:
generate the image based on an execution of an application;
provide a user interface that includes a graphical control that is operable to submit a user command; and
generate the image in response to the user command submitted via the graphical control.
